(19) United States
(12) Patent Application Publication
(10) Pub. No.: US 2007/0250711 A1
(43) Pub. Date: Oct. 25, 2007

(54) System and method for presenting and inputting information on a mobile device

(75) Inventor: James S. Storey, Berkeley, CA (US)

Correspondence Address: BAKER & MCKENZIE LLP;PATENT DEPARTMENT, 2001 ROSS AVENUE, SUITE 2300, DALLAS, TX, 75201, US

(73) Assignee: PHONIFIED LLC, Berkeley, CA (US)

(21) Appl. No.: 11/460,205

(22) Filed: Jul. 26, 2006

Related U.S. Application Data
(60) Provisional application No. 60/745,542, filed on Apr. 25, 2006.

(51) Int. Cl. H04L 9/00

(52) U.S. Cl. 713/168; 709/223

(57) ABSTRACT

Disclosed are combinations of authentication, session management and web scraping implemented on a mobile device to support a rich mobile application using secure connections to existing websites to access data sources. The mobile application presents information in logical units rather than screen by screen, and fetches data in the background for low perceived delay. The mobile application provides consistent navigation using the 12-key or QWERTY keypad. The mobile application maintains a history of screens, allowing the user to easily return to a prior screen. A web server allows phrases to be configured on-line by an individual user and downloaded to that user's mobile device to simplify data entry on the mobile device. A method of embedding user profile information in a signed application executable file that allows applications to be pre-configured per user. A licensing mechanism that supports multiple distribution channels.

### CROSS REFERENCE TO RELATED APPLICATIONS

This application claims the benefit of provisional patent application Ser. No. 60/745,542, filed Apr. 25, 2006 by the present inventor.

### BACKGROUND OF THE INVENTION

1. Field of the Invention

This invention relates generally to user interaction with a mobile data device for the purpose of accessing networked information.

2. Related Art

Various technologies and software applications exist for accessing information from a mobile device such as a wireless PDA or a data-capable mobile phone. The majority of these approaches focus on compensating for the very limited bandwidth of early mobile data networks. With current 2.5G and 3G networks providing higher bandwidth and lower latency, new techniques for supporting mobile data application are possible.

Mobile web browsers have been available for several years which allow a user to retrieve a page of information, scroll through that page, and go to the next page or a related page via a link.

Mobile platforms such as JavaME (formerly J2ME™), Qualcomm brew™, PalmOS®, Symbian OS™, Windows Mobile® and others provide base components that allow network connection and presentation of data to the user. Numerous applications have been implemented on these platforms to present information to users.

The most common structure for mobile applications, either as downloaded applications or browser based, is as a menu tree. Best practices recommend using a “Back” key to go back to the previous menu, so the user can navigate up and down the menu tree.

Certain solutions such as WebBee or the Opera Mini browser provide simplified mobile access to services such as email or web browsing via a hosted intermediate server. The server re-purposes the content to fit on the specific end device.

The technique of web scraping, or extracting context specific data content from an HTML document, has been commonly used on servers and in some PC applications. This technique has also been documented for JavaME applications, for example in the Sun Java Technical Article and Tips by Eric Giguere.

The IETF has defined the BASIC and DIGEST authentication mechanisms in RFC 2617. Web servers like Apache and Microsoft IIS also support a FORM authentication mechanism

The IETF has defined the set-cookie and set-cookie2 techniques for maintaining state between an HTTP client and server in RFC 2109 and RFC 2965.

Cookie management is not supported by certain wireless platforms like JavaME. Bansal and Yuan and Long have discussed approaches to managing cookies in the application or on an intermediate server.

U.S. Pat. Nos. 5,963,952, 6,192,380, and 7,047,033, and U.S. Patent Applications 20040230536A1 and 20040230647A1 propose solutions for automatically populating the fields of a web browser form. These solutions work in the context of a PC based browser, with the values for the fields being stored on the PC or on an intermediate server.

PC based browsers and some PC applications support a history of visited pages, that allows the user to go back to pages previously visited. In U.S. Pat. No. 7,010,758, Bate describes a system to provide a history of pages maintained on a server to allow the user to jump to a specific visited page.

Mobile devices typically provide either a full alphabetic (QWERTY) keypad, or a 12 key numeric keypad. A number of techniques have been developed for entering text using the 12 key keypad, including multi-tap and predictive text entry. Certain applications provide pre-defined menus which allow the user to select a choice from a list of options, to reduce the need to enter text on the device.

To ensure the integrity of a downloaded Java application as a Java Archive (JAR) file, the mobile Java platform allows the JAR file to be cryptographically signed by the application provider. Once signed, the JAR file cannot be modified by a third party, so the end user can be confident that the application they are installing is the exact application from the providing company. They can base their decision to install the program on their level of trust of the providing company, without also being concerned about the potential for an intermediate entity to have altered the file, for example, adding a virus. However, the Java application runs in a restricted environment, and in most cases can only access resources that are packaged in the JAR file.

Some mobile application platforms such as JavaME limit the ability of the end user to share copies of the application, by disallowing an application that is installed on the mobile device to be copied from the mobile device to another mobile device or another device such as a PC. However, not all JavaME devices enforce this, and other technologies such as PalmOS and Symbian OS do not have a similar mechanism for protecting the application.

Mobile applications are distributed through a variety of channels, for example, from a development company's website, from third party stores that may support a registration key mechanism, and from wireless carriers that typically do not support a registration key.

Current platforms and applications have the following limitations:

a) Most web pages are not designed for access from a mobile device, so users find it complex to use the mobile device's browser to access networked information.

b) Many application servers do not provide a computer API allowing access via the internet, but do provide a web interface on the internet. For example, many companies deploy an email server which supports a web mail interface, but for security reasons, they do not allow general internet access via IMAP or POP protocols.

c) Documented approaches to automated or computer-assisted form population apply in the context of a user browser session from a desktop PC. To implement mobile application access to standard web sites, it is required to combine this with other techniques such as web scraping and session management.

d) Hosted servers for transcoding or optimizing content for the mobile device require that the user contract with the service provider (the hosting company), and any outages at the hosted server will lead to the data being unavailable on the mobile device. In addition, with this approach, the user is only able to access those sites that are supported by an intermediate wireless server.

e) A hosted service has the potential to view any sensitive data, including passwords, for the end service being accessed. Because the content is reformatted, there is no way to provide secure end-to-end transmission of the information from the source server to the mobile device.

f) Information is accessed one page at a time. After reading each page, the user is required to wait while the next page of information is retrieved via the network. This is exacerbated because of the latency of the wireless data network currently available to most users.

g) Background processing solutions have been documented, but these attempt to cache the full set of information, for example, all email messages on a server, while the user is not actively using the phone. These approaches do not address how to provide low perceived latency when the user accesses un-cached information.

h) Navigation through the page of data is done via the 5-way navigation buttons, or through menus. This is limited to a single “up” and a single “down” gesture, which requires the user to press the up or down key numerous times to get to the information they are interested in.

i) With the limited screen size, applications are not able to display full navigation information. For example, on a PC based browser, many pages display a ‘breadcrumbs’ path that shows exactly where the current page resides in the overall hierarchy of pages, however, on a mobile device, the breadcrumbs would occupy a complete screen or more. Therefore, mobile application users occasionally cannot find their way back to a screen that they visited recently. Solutions have been documented for providing a history of pages on a PC browser, or a history of WAP pages on the server, but these do not address navigating locally within a client application on the mobile device.

j) Even with predictive text or QWERTY keypads, text entry on a mobile device is cumbersome. However, it is not possible for the application developer to forecast all the possible options that a user may want to select, so providing pre-defined options limits the user's capabilities.

k) Current Java applications either support per-user customization but do not use signed JAR files, or provide generic signed JAR files but require the user to manually configure the application in order to customize it.

l) Prior art for software distribution does not address the need for a user specific application. Digital Rights Management (DRM) solutions generate a specific version of the content that is tied to the target device, but these do not account for the need for user customization of the application resources.

m) Mobile Application developers either do not provide any protection against copying for their software, or support multiple copies of the application, one for each licensing scheme they are supporting.

### Objects and Advantages

The objects and advantages of disclosed embodiments of this invention are:

a) Provide a native mobile application tailored to the information being displayed, but at the same time, use standard web protocols with end-to-end security (e.g., HTML over HTTPS) to access the user data on the source server.

b) Allow an organization to deploy specialized mobile applications without needing to change their current internet website or to provide a separate version of the web content such as WAP/WML or mobile XHTML.

c) Allow a mobile application to aggregate data from one or multiple sources without requiring the specific assistance of the provider of the data.

d) Present logical units of text and/or graphics to a mobile data user as a single scrolled document, which is fetched as a background task, simultaneously with the user reading the information that has already been fetched. This provides a much lower perceived latency, and allows the user to process information continually, rather than having to stop and wait at each page boundary.

e) Utilize the 12-key numeric keypad or QWERTY keypad to provide user control over the navigation within a page. Specifically, provide consistent key mappings allowing the user to scroll up or down (by a single line), page up or down (by a single screen of information), and end/home to navigate to the start and end of the document.

f) Provide a “previous” and “forward” history, allowing the user to retrace the history of screens viewed independent of the menu hierarchy.

g) Provide a web server and user accounts and forms where each user can input a custom set of phrases, which are then utilized by the application on the mobile device to allow for rapid text entry. A phrase consists of a label (e.g., “agree”), and a text phrase (e.g., “I have read your message and I agree”). On the device, where data input is required, the user can bring up a menu of phrases specific to the current field being edited, and can select the phrase based on the label, with the result being that the complete phrase is inserted to the current field.

h) Generate a signed application on-demand which is configured for a specific user. The application executable file is automatically generated on a server, and includes user specific details such as their username, password, and preferences. This file is then signed and delivered to the user's mobile device, providing the security of a signed JAR file while tailoring the application to the user.

i) Guard against unauthorized copying or duplication of the application with a general framework that supports different application delivery channels, such that a single application can be used for the various types of licensing used by different channels.

### SUMMARY

Disclosed are systems, methods, and computer program products for presenting information to users using a rich mobile application that accesses a source server using standard, secure internet protocols. Described embodiments provide low perceived latency, for consistent rapid navigation through a logical document and between application screens, and with simplified text input via user-configured phrases. Described embodiments further allow for over-the-air (OTA) deployment of signed Java applications which are pre-configured for a specific end user, and furthermore, described embodiments protect the intellectual property rights of the developer through a general licensing mechanism that can be reused with different distribution channels.

### BRIEF DESCRIPTION OF THE DRAWINGS

For a more complete understanding of embodiments of the invention, and features of the systems and methods herein, reference is now made to the following descriptions taken in conjunction with the accompanying drawings, in which:

FIG. 1 is an overview of a user utilizing a mobile device for networked data access;

FIG. 2 is a block diagram of a method for implementing a rich mobile application combining authentication, session management and web scraping on the mobile device;

FIG. 3 is an illustration of a method for displaying a logical unit of data as a single scrolled document with background fetching of the source data;

FIG. 4 is an illustration of the key bindings for navigation keys using a 12 key numeric keypad;

FIG. 5 is an illustration of the page up command;

FIG. 6 is an illustration of the page down command;

FIG. 7 is an illustration of the key bindings for navigation keys using a QWERTY alphabetic keypad;

FIG. 8 is a illustration of the screen navigation history;

FIG. 9 is a block diagram of a method for web editing of custom user phrases for rapid entry on a mobile device;

FIG. 10 is an illustration of text entry on a mobile device using phrase lists;

FIG. 11 is a block diagram of a method for generating signed application files with user specific resource files;

FIG. 12 is a block diagram of a method for protecting mobile data applications using a downloaded license file; and

FIG. 13 is a block diagram of a method for protecting mobile data applications using a registration key or an application key.

The illustration of features within any embodiment or diagram by itself should in no way be construed to mean that such features may only be employed in the particular illustrated embodiment or diagram. One of ordinary skill in the art would appreciate that features from various embodiments may be combined in various ways according to the design needs in a particular commercial application. The scope of the inventions claimed in the present application should be broadly construed in light of any claims issuing herefrom, and should not be limited by particular embodiments disclosed in the application.

Reference Numeral Key:

| | |
|---|---|
| 101 User | 102 Mobile Device |
| 103 Mobile Data Network | 104 Web Server |
| 105 Company Internal | 106 Application Server or Database |
| Network | |
| 201 Mobile Application | 202 User Interface Module |
| 203 Data Storage Module | 204 Processing Logic Module |
| 205 Web Scraping Module | 206 Session Management Module |
| 207 Cookie Database | 208 Authentication Module |
| 209 Authentication Data | 210 Data Communications Module |
| 213 User Account Data | 301 Data Server |
| 302 Complete Document | 305 Parsing Module |
| Source | |
| 306 Local Formatted Copy | 307 Subset of the Document |
| of Document | |
| 308 Display Screen | 400 Help |
| 401 Page Up | 402 Scroll Up |
| 403 Home | 404 Up |
| 405 Do | 406 Down |
| 407 Page Down | 408 Scroll Down |
| 409 End | 501 Original Screen Prior to Page Up |
| 502 Screen Following Page | 503 Screen Following Page Up with a |
| Up | Large Line |
| 601 Original Screen Prior to | 602 Screen Following Page Down |
| Page Down | |
| 603 Original Screen With a | 604 Screen Following Page Down after |
| Large Line as the | Large Line |
| Bottom Line | |
| 700 Help | 701 Page Up |
| 702 Scroll Up | 703 Home |
| 704 Up | 705 Do |
| 706 Down | 707 Page Down |
| 708 Scroll Down | 709 End |
| 801 Hierarchy of Screens | 802 Screen History Stack |
| 803 Current Screen Pointer | 901 User PC |
| 902 Web Browser | 903 Phrase Editing Form |
| 904 Internet Connection | 907 User Phrase List |
| 909 Push Communications | 910 Local Copy of Phrases |
| Channel | |
| 1001 Input Form | 1002 Text Entry Field |
| 1003 Phrase Selection Menu | 1004 Phrase Text |
| 1101 Server Computer | 1102 Request for Application Download |
| 1103 Base Application Files | 1105 User Specific Resource Files |
| 1106 Signing Certificate | 1107 Application Packaging Program |
| 1108 Application Signing | 1109 Signed Application File |
| Program | |
| 1110 Download Notification | 1113 Local User Specific Resource Files |
| Channel | |
| 1114 Installed Application | 1201 Development Company Server |
| 1202 Application Executable | 1203 User License Data |
| File | |
| 1204 Application Download | 1208 Local License Data |
| Channel | |
| 1303 Intermediate | 1304 Registration Key Request Channel |
| Organization Server | |
| 1310 Email Communications | 1312 Email Message |
| Channel | |

### DETAILED DESCRIPTION

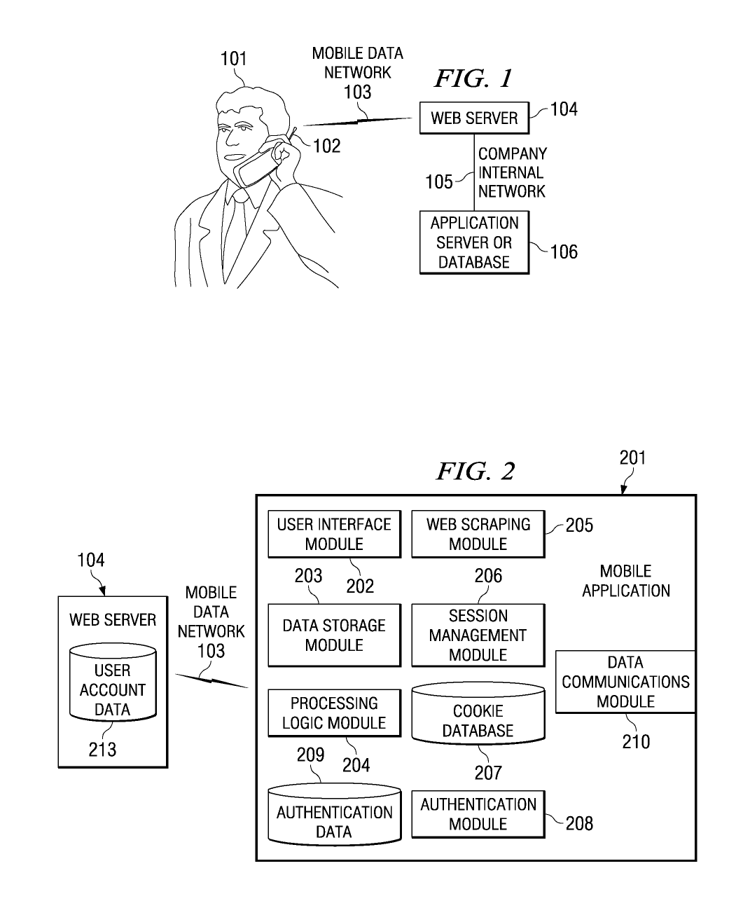

The disclosed embodiments are directed to user interactions with mobile devices to provide a high quality user experience despite limitations of the device and network. FIG. 1 illustrates a user interacting with a mobile data application that accesses networked information. A User (101) interacts with a Mobile Device (102), which is connected via a Mobile Data Network (103) to a public-Internet accessible Web Server (104). The Web Server communicates via a Company Internal Network (105) to an Application Server or Database (106), which provides the source of the information content. Note that the Web Server and Application Server or Database may be co-located, in which case they may be referred to as the Web Tier and Data Tier.

Illustrated in FIG. 2 is an implementation of a rich mobile application using standard web protocols to access user data along with the teachings of the present invention. Disclosed embodiments accordingly allow a rich mobile application to be implemented for accessing user specific data content from public or enterprise servers, even when no machine API to that data is available. FIG. 2 illustrates the components of one such solution.

The Mobile Application (201) consists of a User Interface Module (202), a Data Storage Module (203), and a Processing Logic Module (204). Unique to this invention is the combination of a Web Scraping Module (205), a Session Management Module (206), and an Authentication Module (208) on the Mobile Device (102). The Authentication Module includes Authentication Data (209) for a User. The Session Management Module includes a Cookie Database (207) that stores session tokens or “cookies”. The Web Scraping Module and Session Management Module communicate with a Web Server (104) via a Mobile Data Network (103). In particular, the Mobile Application downloads and modifies User Account Data (213) that contains information specific to the user.

With further reference to FIG. 2, the operation of an embodiment will now be described. Upon initial communications between a Data Communications Module (210) of a Mobile Application (201) and a Web Server (104) via a Mobile Data Network (103), an Authentication Module (208) negotiates an authentication sequence. Authentication is typically done in one of three manners: form, basic, or digest.

The Mobile Application maintains Authentication Data (209) for the user for this application, typically as a username and password. For example, this could be populated from entry in the mobile application user interface, or by downloading configuration data from a web server, or pre-populated in the application as a resource file specific to this user.

In the case of form authentication, when a request (e.g., HTTP POST or HTTP GET) is sent to the web server for a page that requires authentication, the web server returns a redirect message (e.g., HTTP 302), with a location of a login form. The Data Communications Module checks the location of any redirect request against a list of possible login pages. The list of pages is tailored for each application. If the location is a possible login page, the redirected page is fetched, and the page contents are processed by a Web Scraping Module (205) to extract the field names used for the credentials (typically this is username and password). The Web Scraping Module is capable of reading the login form, extracting text and password input fields, and comparing the name of the fields to determine the actual field used to submit the username and the password. The specific application can customize the rules for determining the username and password fields. An application may specify a hard rule that the username field is always the form input element named “username”, or may specify a sequence of possible names, in which case the Web Scraping Module will return the form input element present in the login page which matches the lowest order item in the sequence. For example, if the application indicates that the username fields can be “user”, “username” and “aUser”, if the form contains an input element named “username”, but does not contain a user element named “user”, then “username” is selected as the name of the parameter to be utilized for sending the user name part of the authentication credentials. The Web Scraping Module also extracts any hidden fields, which is often used for specifying context, for example, the page to redirect to once the login is complete.

The Authentication Module then accesses the Authentication Data to get the current value of the username and password, and creates the content of an HTTP POST message by adding properties for the username and password, in the format “username=myname&password=mypassword”, and also adds any hidden fields and the values of the hidden fields. This HTTP POST message is then sent to the web server, mimicking the operation of a PC Browser submitting a form when the user enters their username and password and clicks on the login button.

In the case of basic or digest authentication, when a request is sent to the web server for a page that requires authentication, the web server returns an HTTP Unauthorized message (error 401). In the case of digest, the web server also sends a header field www-authenticate that contains the nonce and encryption data. The Data Communications Module checks for this response, and if received, requests an authorization property from the Authentication Module. The Authentication Module fills out the property according to the rules for basic or digest authentication, again using the Authentication Data as the source of the username and password values. The Data Communications Module then retries the HTTP operation, including a header field with the authorization property.

For any interaction with the server, a Session Management Module (206) maintains session state using the HTTP Cookie mechanism, as described in RFC 2019 and RFC 2965. In particular, the Session Management Module maintains the cookies required for authenticated user state. For each HTTP request to the web server, the Data Communications Module queries the Session Management Module for the cookies currently stored for the specific URL to be accessed, and adds this as a header to the HTTP operation. In addition, the Data Communications Module extracts the cookies returned in the headers of all responses, and provides these to the Session Management Module. The Session Management Module stores these cookies according to the domain and path, in order to provide them on subsequent HTTP operations.

The application interacts with the user through a series of User Interface screens and through data entry which could include keypad input, touch-screen input, external keyboard input, etc. Unlike a mobile web browser, the application is able to immediately display data that is stored locally in memory or in persistent storage. The data is stored as structured data, so specific items can be processed and stored efficiently, for example, a string representing a date can be parsed as a date and stored in a compact format, and can be compared to other dates.

As a consequence of the Session Management capability, the interaction with the web server is state-full, and in particular, can be specific to the individual user following the authentication. This allows the application to manipulate the User Account Data on the web server.

A Processing Logic Module (204) can utilize the local data to customize the application for the user. For example, the Mobile Application can download preferences or user profile from the User Account Data. A User Interface Module (202) can display specific screens based on the user preferences. In addition, the local data can reduce the need for text or data entry, which is difficult on most mobile devices. For example, instead of requiring free form text input for a given field in a User Interface form, the local user preferences can indicate a default value, which the user is not required to change if they choose to use this default value. Because the application is able to access the User Account Data, the default value can be different for each user.

If the application requires information that is not stored locally, a request (e.g., GET or POST) is sent to the web server. The response is processed by the Web Scraping Module, and converted from the HTML into structured data. For example, if the web server application is a web interface to email, the structured data may be a Message object, with attributes for from, subject, cc, date, and body. The Web Scraping module is able to process most common HTML documents, including legacy documents that are not well structured. This includes tags that are not terminated with a closing tag, attributes whose values are not enclosed in quotation marks, and case-insensitive tag names. The structured data can be stored persistently and later fetched by a Data Storage Module (203).

A special case of the Web Scraping Module processing is to convert a section of the HTML into plain text, compacted for the mobile display. The conversion to plain text incrementally converts the HTML stream into tags and entities. Each tag or entity is processed in sequence. Entities are converted into an appropriate display character, for example, &nbsp; is converted to Unicode \u00a0 and &bull; is converted to Unicode \u2022. If the entity is a quoted character, e.g., &#NNN or &#xNNN, this is converted into a Unicode character. Because certain mobile platform implementations cannot display certain Unicode characters, the characters resulting from the entity conversion are checked against a list of problem characters, and if in the list of known problems, they are replaced with an indicator character, for example ‘?’.

For the end of any tags that are block oriented by convention, a new-line is added to the plain text. These block tags include BR, HR, LI, DIV, TD, H1, H2, H3, H4, H5, H6, and P. In addition, because many pages use <P> as a new paragraph without a corresponding end tag, at the start of the tag <P> a new-line is also added to the plain text. Tags LI, OL, and UL are processed, such that each OL item is preceded by an incrementing counter (1, 2, 3, . . . ), and each UL item is preceded by a bullet character.

The preformatted tag <PRE> is also processed such that any text within a PRE block is processed directly without formatting other than white-space reduction as described below.

As the plain text stream is being created, extra white-space is removed. In particular, any sequence of new-line or carriage return followed by multiple white-space including new-lines or carriage returns, followed by a final new-line or carriage return followed by non-white-space prior to the subsequent new-line or carriage return is converted to a single new-line followed by a second new-line, followed by the line with non-white-space. In this fashion, vertical white-space, that is, blank lines, are compressed to make the best use of the limited display area on the mobile device. The plain text can then be shown on the mobile device display in a format that is easily read by the user.

If dictated by the user interaction, the application may need to update User Account Data on the web server. In this case, the application Processing Logic Module will provide the parameters and URL to the Data Communications Module, which will format and send an HTTP GET or HTTP POST request, based on what is expected by the web server. The parameters are populated from data in persistent storage or in memory, either as entered by the user, or retrieved from other sources such as a previous web server interaction, or from processed data from either or both of these sources. The response will be processed to determine success or failure of the operation, and possibly to extract data values or to format messages as plain text to display to the user.

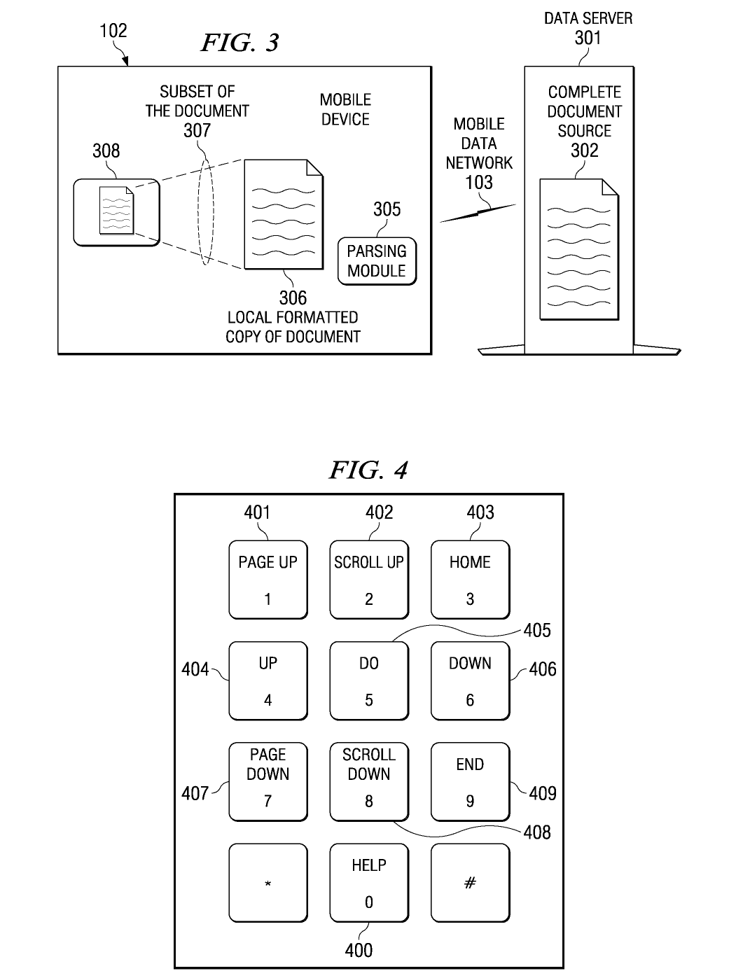

Illustrated in FIG. 3 is an embodiment in which a mobile device loads and displays information based on complete logical documents, providing the opportunity to present information in complete documents rather than single pages. A Complete Document Source (302) resides on a Data Server (301) that is accessed from a Mobile Device (102) via a Mobile Data Network (103). Communications over the mobile data network connection may be based on web protocols such as HTTP or HTTPS, email protocols such as POP or IMAP, or may be XML or a binary protocol via TCP/IP, or other protocols. A Parsing Module (305) converts the document to a format appropriate for display on the device. A Local Formatted Copy of the Document (306) is loaded on the mobile device. This local copy may be stored in non-volatile storage or may be retained only in memory. A Subset of the Document (307) is displayed to the user on a mobile device Display Screen (308). Note that for a short document, the subset may be the entire document.

With further reference to FIG. 3, the operation of an embodiment for presenting logical documents will now be described. The user of the mobile application selects a specific document to read, for example, an email message or sales report. If the document is stored in memory or non-volatile storage on the mobile device, a Subset of the Document (307) corresponding to the first screen of the document is rendered and displayed to the user. If the document is not resident on the mobile device, then a Mobile Data Network (103) is used to communicate with a Data Server (301). The Complete Document Source (302) is downloaded from the server using a background thread. If the document is in a plain text format, then as it is read from the server, it is stored in memory and also rendered on the screen.

As described above, if a document is in a specific format such as MIME or HTML, then a Parsing Module (305), which may be either a pull parser such as an implementation of the XmlPullParser API or a push parser like a SAX parser is utilized. The pull and push parsers are able to process the stream of data incrementally, in contrast to a document parser (e.g., DOM) which needs to parse the entire document before it can be operated on. In this fashion, the Subset of the Document corresponding to the first screen of information can be rendered as soon as the corresponding data for that screen has been received from the server. While the user is reading the information on the initial subset of the document, the remainder of the document is fetched from the server.

Illustrated in FIGS. 4, 5, 6, and 7 are embodiments in accordance with the present invention that provide for bindings to facilitate navigation through documents at different levels of granularity, or in other words through different document hierarchies.

The embodiment described in FIG. 4, for example, defines key bindings for a 12-key numeric keypad to allow for document navigation. The key bindings are illustrated in FIG. 4.

Referring specifically to FIG. 4, the 1 key is mapped to Page Up (401). The 7 key is mapped to Page Down (407). The 2 key is mapped to Scroll Up (402). The 8 key is mapped to Scroll Down (408). The 3 key is mapped to Home (403). The 9 key is mapped to End (409). The 4 key is mapped to Up (404). The 6 key is mapped to Down (406). The 5 key is mapped to Do (405). The 0 key is mapped to Help (400).

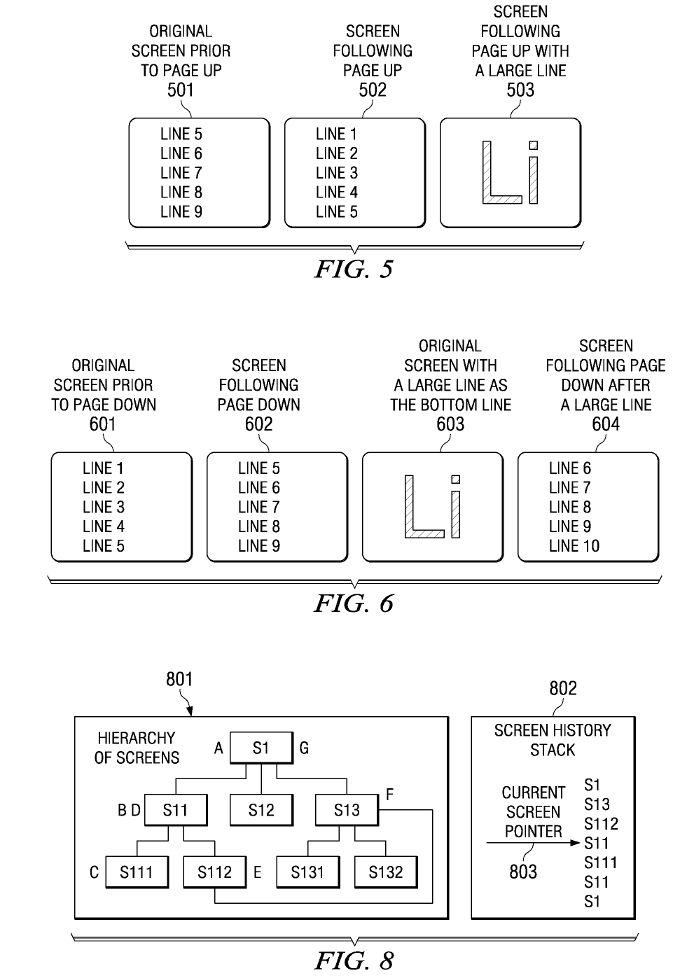

The displayed document is illustrated in FIG. 5 and FIG. 6. An Original Screen Prior to Page Up (501) shows a set of displayed lines of text corresponding to a subset of the overall document. Note that this could also include a mixture of text, still, and moving graphics, but for illustration purposes, a text-only document is used as the example. A Screen Following Page Up (502) shows a different set of displayed lines of text. A Screen Following Page Up with a Large Line (503) shows a single displayed line consisting of large font text. Note again, this could instead be a line with text and graphics, where the graphics height is close to or greater than the available display height of the screen. An Original Screen Prior to Page Down (601) shows a set of displayed lines of text corresponding to a subset of the overall document. A Screen Following Page Down (602) shows a different set of displayed lines of text. An Original Screen with a Large Line as the Bottom Line (603) shows a single displayed line consisting of large font text. For this example, this line represents line 5 of the document. A Screen Following Page Down after a Large Line (604) shows a different set of displayed lines of text.

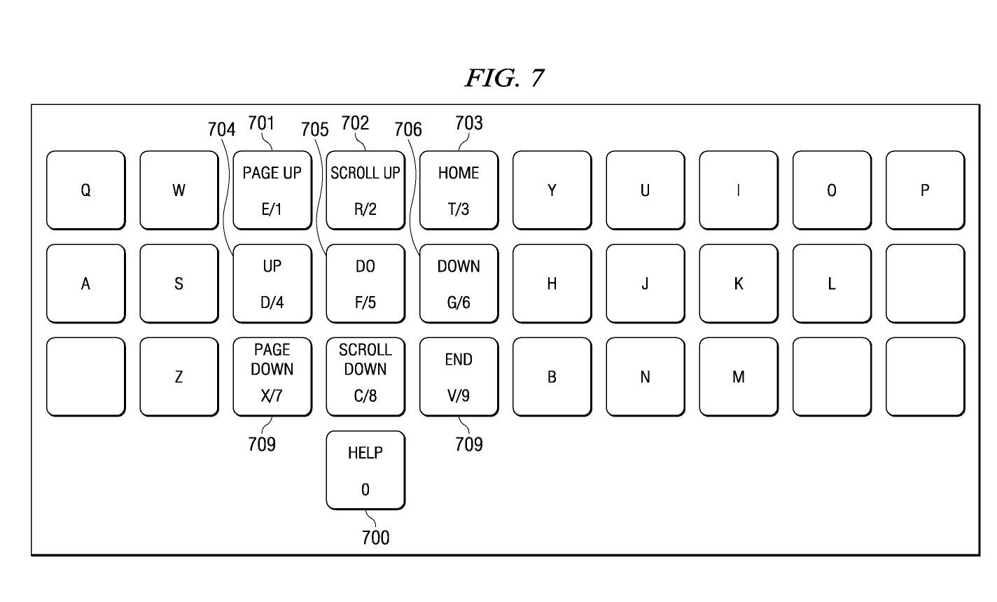

This embodiment defines key bindings for a QWERTY keypad to allow for document navigation. Most QWERTY devices provide dual labeled keys, which allow a set of alphabetic keys to be used for numeric input. For those devices, the key mapping for the 12 key keypad is used, according to the device's mapping of digits to alpha keys, which may not correspond exactly to the illustration in FIG. 7. The letter keys are used directly, so the user does not need to press the numeric shift key first. For devices that do not provide dual labeled keys, then the mapping shown in FIG. 7 is used. In the following description, the numeric label for devices that provide dual labeled keys is given, as well as the alphabetic label for devices that do not provide dual labeled keys.

The key bindings for an exemplary dual labeled keyboard are illustrated in FIG. 7. The 1 key/e key is mapped to Page Up (701). The 7 key/x key is mapped to Page Down (707). The 2 key/r key is mapped to Scroll Up (702). The 8 key/c key is mapped to Scroll Down (708). The 3 key/t key is mapped to Home (703). The 9 key/v key is mapped to End (709). The 4 key/d key is mapped to Up (704). The 6 key/g key is mapped to Down (706). The 5 key/f key is mapped to Do (705). The 0 key/v key is mapped to Help (700).

With further reference to FIGS. 4-7, the operation and use of the above described navigation commands in a document are further described, in which embodiment a subset of keys of the 12-key numeric keypad or the 26-key QWERTY keypad is mapped to navigation commands for a document.

When the user presses the key mapped to Page Up (401 and 701), the display screen changes to display the previous one screen of data in the document. For continuity, the top line of text or images in the Original Screen Prior to Page Up (501) is shown as the bottom line of the Screen Following Page Up (502), but in any case, scrolling no less than one line worth of data. Specifically, if the line immediately prior to the top line requires a line height that does not allow the top line to also be displayed, then the previous line is displayed without displaying the top line as shown in Screen Following Page Up with a Large Line (503). Page Up has no effect if the first line of the document is currently displayed.

If the underlying platform provides an appropriate display widget with support for application control of the scroll position, then the platform display widget can be used for rendering the document on the screen. If the underlying platform does not provide a suitable display widget, then the application code must implement the document rendering, and use a low level API to paint the document text and images at the correct position on the display screen.

When the user presses the key mapped to Page Down (407 and 707), the display screen changes to display the next one screen of data in the document. For continuity, the bottom line in the Original Screen Prior to Page Down (601) is displayed as the top line of the Screen Following Page Down (602). However, if the bottom line of the original screen has a line height that does not allow the next line to be displayed as in Original Screen with a Large Line as the Bottom Line (603), then the next line is displayed without displaying the previous bottom line as in Screen Following Page Down after a Large Line (604). Page Down has no effect if the last line of the document is currently displayed.

When the user presses the key mapped to Scroll Up (402 and 702), the display screen changes to display the previous line of data in the document. Scroll Up has no effect if the first line of the document is currently displayed.

When the user presses the key mapped to Scroll Down (408 and 708), the display screen changes to display the next line of data in the document. Scroll Down has no effect if the last line of the document is currently displayed.

When the user presses the key mapped to Home (403 and 703), the display screen changes to display the beginning of the document. If the beginning of the document is already visible on the screen, then Home has no effect.

When the user presses the key mapped to End (409 and 409), the display screen changes to display the end of the document. If the end of the document is already visible on the screen, then End has no effect.

When the user presses the key mapped to Up (404 and 704), the application navigates to the screen that is the parent of the current screen in the application hierarchy.

When the user presses the key mapped to Down (406 and 706), the application navigates to the screen that is the child of the current screen in the application hierarchy. Note however, that the meaning of the child screen and the specific child screen to select from multiple child screens is dependent on the application and the current context.

When the user presses the key mapped to Do (405 and 705), the application executes the default operation for the current screen and the current context. For example, if the screen displays the details of an email message, the Do key may be defined as Next, to display the next message in sequence.

When the user presses the key mapped to Help (400 and 700), this brings up a help screen. If the application provides context sensitive help, then the help text will be appropriate to the current screen and context. If not, then the help text may be general text for the entire application.

In the embodiments described in the present application, additional key mappings may be advantageously used. For example, key mappings may be provided for navigation in a screen where the displayed information is a List of items. Key mappings may be provided to navigate in a screen where the displayed information is a Menu of options for the user to select. Key mappings may also be provided to navigate in a screen where the displayed information is a Form for entering data.

FIG. 8 illustrates an embodiment in which a screen history stack is maintained to enable users to easily retrace their navigation paths and visit previous screens. In addition to the specific screen visited, the context for that screen can be maintained, for example, for an email program, the history remembers both that the message screen was visited, and which message was displayed.

FIG. 8 accordingly illustrates the structure of the application. The mobile application is organized as a tree structured Hierarchy of Screens (801), that is visited in a sequence a, b, c, . . . , as annotated in 801. The application supports navigation up and down the hierarchy, and the ability to “jump” to related screens. This invention also maintains a Screen History Stack (802), along with a Current Screen Pointer (803).

With further reference to FIG. 8, the operation of an embodiment using this approach will now be described. As the user interacts with the application, they visit a sequence of screens in the Hierarchy of Screens (801). In FIG. 8, this sequence is denoted as a, b, c, d, e, f, g, as the user visits the screens a) S1, b) S11, c) S111, d) S11 (again), e) S112, f) S13 via a hyper-link that jumps across the standard Hierarchy, and finally g) S1 (again).

As each screen is visited, the application stores the screen and any context needed to reproduce the current display on the screen, in a Screen History Stack (802). A navigation option is provided which allows the user to go to the previously visited screen. If the user has retraced part of their history, then they can go forward in the history to replay the navigation steps. The navigation options consist of the options Previous, Next, and History. Previous goes to the immediate previous screen in the History Stack. Next goes to the immediate next screen in the History Stack, or has no effect if the user is at the last screen in the History Stack. History brings up a list of the entire history, and allows the user to navigate to a particular screen plus context. A Current Screen Pointer (803) stores which screen in the history stack is currently displayed.

Because the available memory is often limited, the stack can have a defined size limit, for example, the most recent 100 screens. In this case, as the user visits more screens than the stack size limit, the earlier history is discarded. In addition, if the user is at the first screen in the history stack, then the Previous command has no effect.

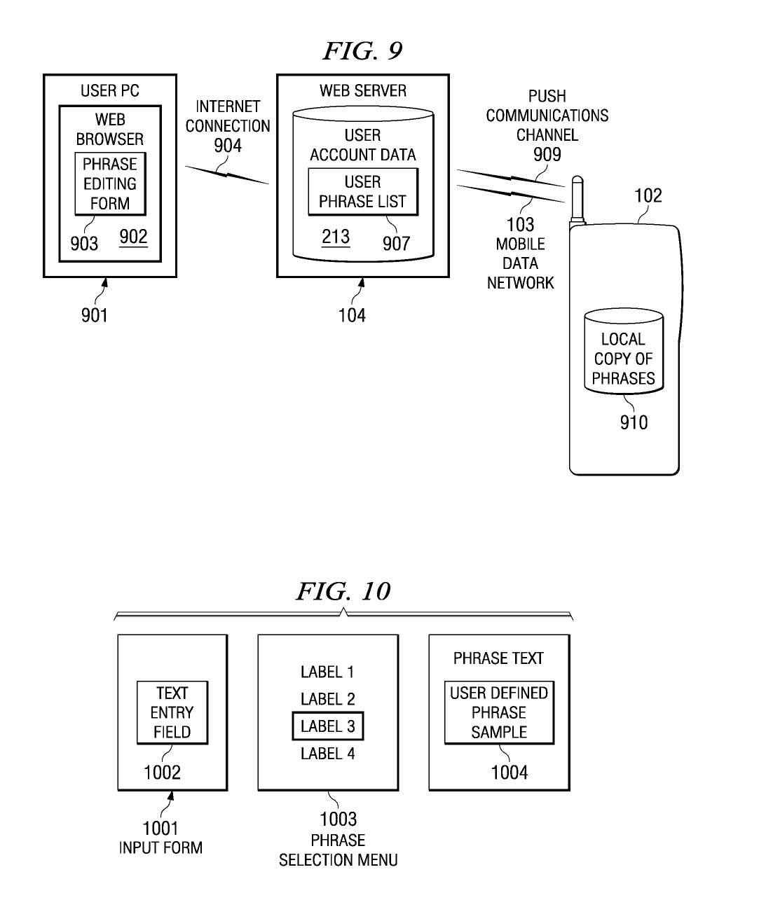

Illustrated in FIGS. 9-10, embodiments are provided by which a user can manage their own customized phrase lists. These customized phrase lists facilitate easy data entry by the mobile device user.

As shown in FIG. 9, the described embodiment enables the user to edit an individual User Phrase List (907) by accessing a Web Server (104) using a general purpose Web Browser (902) running on a User PC (901), connected via an Internet Connection (904). The web server presents a Phrase Editing Form (903), for example, an HTML form, to the user, and if an update is submitted, the web server updates the User Account Data (213). For a given application, there can be one or more phrase lists defined, and a specific phrase list can apply to one or more text fields of a mobile data application. The web server and a Mobile Device (102) can communicate via a Push Communications Channel (909), or via a Mobile Data Network (103) in a pull mode. A local copy of the phrases (910) is stored in non-volatile memory on the Mobile Device.

FIG. 10 illustrates the entry of text on the mobile device according to this embodiment. A mobile application includes Input Forms (1001) for entering data, which may contain one or more Text Entry Fields (1002) for entering text. A menu option allows the user to pick a phrase to enter in the text field at the current cursor position. Selecting this menu choice brings up a Phrase Selection Menu (1003) which lists the labels for the phrases, and allows the user to select a specific phrase. When a phrase is selected, the Phrase Text (1004) corresponding to the phrase is inserted to the Text Entry Field.

With further reference to FIG. 10, the operation of an embodiment using this approach will now be described. The user logs onto their user account on a web server (104) from a Web Browser (902) on their User PC (901). After logging on, the user is able to bring up a Phrase Editing Form (903) and to enter personalized phrases either globally for the entire application, or specific to a given field of the application. For example, for an email application, there may be a set of phrases for the body of the messages, and a different set of phrases for the subject of the messages. Each phrase consists of a label, which is a short name for the phrase, and the value, which is the full text for the phrase.

Still referring to FIG. 10, the User Phrase Lists (907) are stored as part of the User Account Data (213) on the web server, so that each set of phrases is associated with a specific User. After updating the phrases, the web server can push these to a Mobile Device (102) on a Push Communications Channel (909), for example, by sending an SMS message to a specific port that activates a Java MIDlet application. Alternatively, the application can connect to the web server using a Mobile Data Network (103) and download the Phrases. After the phrases are pushed or downloaded, they are stored as a Local Copy of Phrases (910) on the Mobile Device in non-volatile memory, and are associated with a specific Text Entry Field (1002) on an Input Form (1001) on the Mobile Device.

As the user is interacting with the application on the Mobile Device, when they are prompted for data input, they can choose to edit the field and use the Mobile Device's native mechanisms for entering text such as multi-TAP or predictive text entry, as is common practice, or they can choose to insert a phrase. In the case where they choose to insert a phrase, the user is presented with a Phrase Selection Menu (1003) which displays a list of the labels for the phrases as entered by the user on the web server. When the user selects the desired phrase, the corresponding Phrase Text (1004) for the phrase is inserted to the Text Entry Field. If the Text Entry Field supports a cursor position, then the text is inserted at the cursor position.

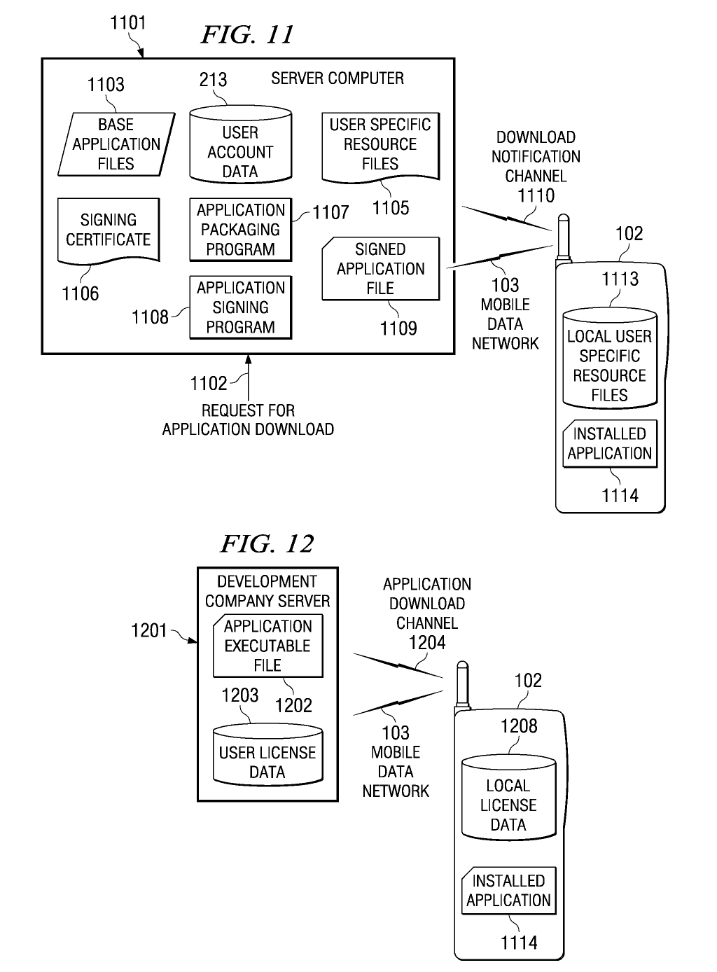

FIG. 11 illustrates an embodiment which provides the security of signed applications while still allowing the application to be pre-configured or otherwise tailored to a specific user. In this embodiment, a Server Computer (1101) stores Base Application Files (1103) that make up the application. Typically, these will include a combination of resource files like images and configuration files, object code files, and libraries of object code archives. The Server Computer maintains a database of User Account Data (213), and stores or generates on demand a User Specific Resource File or Files (1105). The Server Computer also stores a code Signing Certificate (1106) for the application provider, procured from a trusted certificate authority. The Server Computer hosts an Application Packaging Program (1107) which can package the files into a deployable application, for example, a java archive (JAR) program. The Server Computer also hosts an Application Signing Program (1108) to sign the application, for example, this could be an ant script which computes a signature and generates a signed JAR file.

As shown in FIG. 11, a generated Signed Application File (1109) is stored on the Server Computer. A download notification channel (1110) allows the Server Computer to inform a Mobile Device (102) of the availability and location (URL) of the signed application. The Mobile Device can download the application over a Mobile Data Network (103). After download, an Installed Application (1114) resides on the Mobile Device, and can access Local User Specific Resource File(s) (1113).

With further reference to FIG. 11, the operation of an embodiment using this approach will now be described. An event triggers a Request for Application Download (1102) on a Server Computer (1101). This event may be the result of the user purchasing the application, or if the application is free, may be triggered by the user clicking on a “download” button on a website form. The event could be a web protocol such as an HTTP POST, or a SOAP operation, an inter-process (IPC) call from a provisioning system, or other mechanisms for conveying events.

In response to the Request for Application Download, the User Account Data (213) stored persistently or in memory on the server computer is used to populate a User Specific Resource File or Files (1105). For example, if the mobile application will access a web server account, the resource files may include the web server username and account. Or, the resource files may include preferences that were configured by the user on the Server Computer.

Next, an Application Packaging Program (1107) combines the Resource File(s) with a collection of Base Application Files (1103) to create an Application Executable File. For example, the Application Packaging Program may be the Java Archive (JAR) tool which creates a JAR file.

Next, an Application Signing Program (1108) processes the Application Executable File along with a Signing Certificate (1106) provided by a Trusted Certificate Authority to create a Signed Application File (1109). The Server Computer then uses a Download Notification Channel (1110) such as an SMS message or WAP Push message to notify the Mobile Device (102) for the User that the application is available. Typically, this will use the Mobile Telephone Number that the User provides as part of their account data to send the message to the correct Mobile Device.

As a result of getting the notification message, the Mobile Device or the User interacting with the Mobile Device will contact the Data Server, and will download and install the application over a Mobile Data Network (103), causing an Installed Application (1114) to be present on the Mobile Device. When the user executes the Installed Application, the Local User Specific Resource Files (1113) are available to the application.

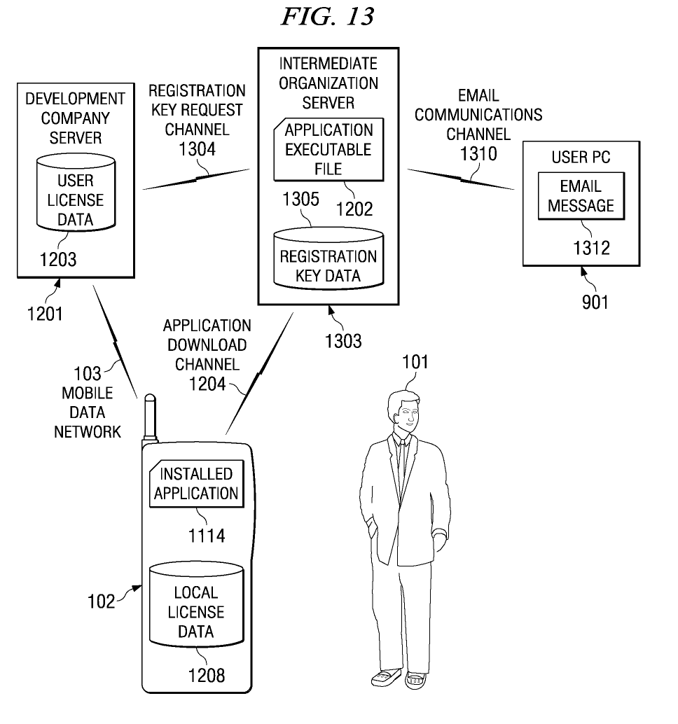

As illustrated in FIGS. 12 and 13, an additional embodiment provides a general framework for license protection for direct and channel distribution, allowing a single application to be configured via a license file for one of several licensing mechanisms, including, for example, (1) direct sales, from the web server of the company providing the application (providing company); (2) channel sales with license registration, where the channel sends a request to the providing company for a registration key for each license sold; and (3) channel sales where the channel does not request a registration key for any license sold.

FIG. 12 illustrates an exemplary embodiment of a system for license protection of the application when the application is downloaded directly from the development company server. In this embodiment, a Development Company Server (1201) stores in non-volatile memory an Application Executable File (1202). The Development Company Server also stores User License Data (1203). An Application Download Channel (1204) allows the Application Executable File to be downloaded from the Development Company Server to a Mobile Device (102) and to be installed as an Installed Application (1114) on the Mobile Device. A Mobile Data Network (103) allows the Installed Application to download a copy of the User License Data as Local License Data (1208) on the Mobile Device.

FIG. 13 illustrates an exemplary embodiment of a system for license protection of the application when the application is downloaded from an intermediate organization's data server. In this embodiment, a Development Company Server (1201) stores a database of User License Data (1203). An Intermediate Organization Server (1303) communicates with the Development Company Server via a Registration Key Request Channel (1304), which can use a general internet protocol such as HTTP or can use a specialized protocol such as XML or binary command/response messages over TCP/IP. The Intermediate Organization Server stores a database of Registration Key Data (1305). The Intermediate Organization Server stores in non-volatile memory the Application Executable File (1202). The Application Executable File is provided by the Development Company via electronic transfer or distributed on media such as a CD-ROM. An Application Download Channel (1204) allows the Application Executable File to be downloaded from the Intermediate Organization Server to a Mobile Device (102) and installed as an Installed Application (1114) on the Mobile Device. The Intermediate Organization Server utilizes a general purpose Email Communications Channel (1310) to transmit an email message (1312) containing a registration code to a User PC (901), which is read by the User (101). A Mobile Data Network (103) allows the Installed Application to download a copy of the User License Data as Local License Data (1208) on the Mobile Device.

With further reference to FIGS. 12 and 13, the operation of an embodiment using this approach will now be described. In the case of the direct sale of the application, an Application Executable File (1202) that does not include a license in the resources is packaged. The user purchases a license through an online e-commerce transaction or via phone, email, or other means, which results in a license record being stored for that specific User in the User License Data (1203) on the Development Company Server (1201), and a registration key being transmitted to the user, for example via a confirmation email or on a website. The user contacts the Development Company Server via an Application Download Channel (1204), typically by accessing a URL on a website from a browser on a Mobile Device (102). The Application Executable File is downloaded to the phone. The Mobile Device converts this to an executable Installed Application (1114). Alternatively, the application could be downloaded to the User's PC, and then installed locally via USB, Bluetooth, or other local connections.

After installation, the application is in an initial state. On start-up, it looks for the presence of a license file in the application resources. In this case, no file is found, so the application prompts the user for their username and registration key. The application transmits the username and registration key to the Development Company Server via a Mobile Data Network (103). The Development Company Server confirms that this is the correct registration key for the account associated with the username. Whether or not the registration key is correct, the User License Data is updated to consume the registration key, to prevent against a brute force attempt to guess a registration key. If the correct registration key is provided, a valid license is sent to the application as the response, and the application stores this as Local License Data (1208) in the persistent storage of the Mobile Device. If the Local License Data is valid, the application is activated, and allows full access to the application functions. On subsequent runs of the application, on start-up it reads the Local License Data and confirms that the license is valid, in which case it enables full access to the application functions without the need for communicating with a server.

Further to this embodiment, in the case of an application sold through an intermediate organization (a channel) that supports a registration code, the Application Executable File (1202) includes a license in the resources, and the license indicates that this requires a registration key, and specifies the Intermediate Organization. A user purchases the application through the intermediate organization, either online via an e-commerce application or through other means. An Intermediate Organization Server (1303) contacts a Development Company Server (1201) via a Registration Key Request Channel (1304) and requests a registration key. For example, this may be an HTTP/HTTPS POST operation to a defined URL. The Development Company Server generates a secure random registration key, creates an entry in the User License Data (1203) with the key, and returns the key in the response to the Registration Key Request. The Intermediate Organization provides the Registration Key to the User (101), for example, by sending an Email Message (1312) to the User's PC (901) via an Email Communications Channel (1310).

The user contacts the Intermediate Organization Server via an Application Download Channel, (1204) typically by accessing a URL on a website from the browser on the Mobile Device, and copies the Application Executable File to the Mobile Device. The Mobile Device then converts this to an executable Installed Application, which includes a resource that is the Local License Data (1208). Alternatively, the application could be downloaded to the User's PC, and then installed locally via USB, Bluetooth, or other local connections.

After installation, the application is in an initial state. On start-up, it looks for the presence of a license file in the application resources. In this case, the Local License Data is found. The application prompts the user for the registration key. The application transmits the registration key to the Development Company Server via the Mobile Data Network. The Development Company Server confirms that this is a valid registration key for the Intermediate Organization. If the correct registration key is provided, a valid license is downloaded to the application. The Local License Data is copied to the persistent storage of the Mobile Device. If the Local License Data is valid, the application is activated, and allows full access to the application functions. On subsequent runs of the application, on start-up it reads the Local License Data and confirms that the license is valid, in which case it enables full access to the application functions.

Still further to this embodiment, in the case of an application sold through an intermediate organization (the channel) that does not support a registration code, the Application Executable File includes a license in the resources, and the license indicates that this does not require a registration key, but the license specifies an application key associated with the Intermediate Organization. The user purchases the application through the intermediate organization, either online via an e-commerce application or through other means.

The user contacts the Intermediate Organization Server via an Application Download Channel, typically by accessing a URL on a website from the browser on the Mobile Device, and copies the Application Executable File to the Mobile Device. The Mobile Device then converts this to an executable Installed Application, which includes a resource that is the Local License Data. Alternatively, the application could be downloaded to the User's PC, and then installed locally via USB, Bluetooth, or other local connections.

After installation, the application is in an initial state. On start-up, it looks for the presence of a license file in the application resources. In this case, the Local License Data is found. The application does not prompt the user for any information. The application contacts the Development Company Server via the Mobile Data Network and provides the application key from the Local License Data. The Development Company Server confirms that this is a valid application key for the Intermediate Organization.

If the correct application key is provided, a valid license is downloaded to the application, and the Local License Data is copied to the persistent storage of the Mobile Device. The application is activated, and allows full access to the application functions. On subsequent runs of the application, on start-up it reads the Local License Data and confirms that the license is valid, in which case it enables full access to the application functions.

If it is found that the number of registrations for a given Intermediate Organization exceeds the reported number of applications sold, then this may indicate that an unauthorized copy is being distributed, and the application key bound to that Application Executable File can be disabled on the Development Company Server, which will prevent any future copies of this particular Application Executable File from being activated. In this event, a new Application Executable File is packaged using a different application key, and this is provided to the Intermediate Organization to replace the version that has been disabled.

### CONCLUSION

The approach of combining authentication, HTTP session management, and web scraping, all on the mobile device itself opens up the possibility of rich customized mobile applications for a range of data content. The rich mobile application can store data locally which is specific to that user. This allows for a superior user experience due to faster response because data is available locally, and due to the ability to tailor the application based on the user specific data and preferences.

Web scraping of existing browser web pages allows the mobile application to be deployed without having to implement and maintain a separate set of mobile specific web pages. Furthermore, this allows third-party web servers to be accessed, even if the mobile application developer does not have a specific relationship with the web server content provider.

By implementing the web scraping and session management directly on the mobile device, rather than on a hosted server, the overall solution is more secure and more highly available. The user does not need to worry about the availability of an intermediate server, and there is no need to provide passwords or allow clear text data to transit the third-party server.

By presenting information in complete documents rather than as single pages, the user only experiences a delay at the start of the document download, while the data connection is established and the initial screen's worth of data is downloaded. As long as the speed of downloading, parsing, and rendering the data is faster than the speed at which the user reads the information, the user will not experience additional delays while reading the document. Overall, the aggregate delay experienced is much less than with current practice of page based access, in which the user experiences a delay at the end of each page read.

By using the full keypad rather than just a 5-way navigation key or up and down menu keys, the application is able to give greater navigation control to the user. This supports complete document views, by making it easy for the user to go to a specific section of the document, without having to break the document into smaller “screen-sized” pages. By defining a consistent mapping that applies to all screens, this allows the user to quickly memorize the behavior of the different keys.

User-customized phrases significantly reduce the amount of text entry required on the Mobile Device. Because the user is able to define their own phrases on a website, they can easily edit a number of phrases, and can define phrases that cover the majority of entry options for that user, reducing the chances that a suitable phrase is not available on the Mobile Device.

With current standard practice, if an application is signed for security, then it cannot include any user specific resources. With embodiments of this invention, the application packaging and signing process is included as part of the download procedure, rather than as a static build time procedure, which allows each downloaded application to be customized to a specific user. This can simplify the installation procedure, as the user does not need to enter a username, password, or other configuration information when the application is executed. In addition, this can allow the profile and look-and-feel (theme) of the application to be based on user preferences.

Because it is not possible to prevent the copying or forwarding of a mobile application on all devices, a means of license protection is necessary to limit the unauthorized copies of the application. With embodiments of this invention, a single unified method allows for distribution through multiple channels, which simplifies the code maintenance compared to having multiple code streams, and also ensures a level of application license protection even through channels that do not provide feedback on purchases of the application. Where possible, a registration key is used that allows the activation of each individual application to be tracked to a purchased copy. Where this is not possible, an application key is used to provide high level control over possible unauthorized copies. If a specific version of an application is activated far more times than it is sold, that specific version can be disabled, so that future copies of that version cannot be activated.

The above realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

The section headings in this application are provided for consistency with the parts of an application suggested under 37 CFR 1.77 or otherwise to provide organizational cues. These headings shall not limit or characterize the invention(s) set out in any patent claims that may issue from this application. Specifically and by way of example, although the headings refer to a “Background of the Invention” and a “Summary of the Invention,” the claims should not be limited by the language chosen under this heading to describe technological background for this application nor the top-level description of the embodiments of this application. Further, a description of a technology in the “Related Art” is not be construed as an admission that technology is prior art to the present application. Neither is the “Summary of the Invention” to be considered as a characterization of the invention(s) set forth in the claims to this application or ultimately to any patent that may issue from this application or ensuing continuations and/or divisionals. Further, the reference in these headings to “Invention” in the singular should not be used to argue that there is a single point of novelty claimed in any instance. Multiple inventions may be set forth according to the limitations of the multiple claims associated with this patent specification, and the claims accordingly define the invention(s) that are protected thereby. In all instances, the scope of the claims shall be considered on their own merits in light of the specification but should not be constrained by the headings included in this application, to particular references to “the invention,” nor to particular embodiments described herein.

What is claimed is:

1. A method for accessing a user account on a general-purpose website by a mobile device using a secure communications channel, the method comprising:
requesting, by the mobile device, a response message, wherein the response message is associated with the user account;
providing, by the mobile device, authentication data to the website, wherein the authentication data is associated with the user account;
receiving, at the mobile device, the response message from the website; and
converting, by the mobile device, the response message from hypertext mark-up language to at least one structured data element, wherein the at least one structured data element can be displayed or operated on by the mobile device.

2. The method of claim 1, further comprising:
storing, on the mobile device, a session token, wherein the session token is received from the website, and wherein the session token is associated with the authenticated user account; and
requesting, by the mobile device, a subsequent response message, wherein the subsequent response message includes the session token.

3. The method of claim 1, wherein the providing authentication data to the website comprises:
receiving, from the website, an advisory indicating that the request requires authentication; and
sending a user credential to the website, wherein sending the user credential causes the website to create a session, to authenticate the user account, and to associate the user account with the session.

4. The method of claim 1, wherein the at least one structured data element is a sequence of characters formatted as human readable text.

5. A method for displaying to a user of a mobile device a target section of a document, wherein the mobile device comprises a display device and a data entry device, the method comprising:
retrieving, by the mobile device, an initial section of the document from a data source;
rendering, on the display device, the initial section of the document, wherein the rendering occurs substantially concurrently with the retrieving;
receiving a navigation command from the user, wherein the navigation command is input through the data entry device, and wherein the navigation command is associated with the target section of the document; and
rendering, on the display device, the target section of the document, wherein the rendering occurs substantially concurrently with the retrieving;

6. The method of claim 5, wherein the data source is located in non-volatile storage on the mobile device.

7. The method of claim 5, wherein the data source is external to the mobile device, and wherein the data source is accessed using a communications network.

8. The method of claim 5, wherein the data entry device comprises a keypad comprising at least six input keys, wherein six of the at least six input keys are mapped to the functions PAGE UP, PAGE DOWN, SCROLL UP, SCROLL DOWN, HOME, and END.

9. The method of claim 8, wherein the keypad comprises a standard twelve-key telephone keypad.

10. The method of claim 8, wherein the keypad comprises a standard twenty-six key QWERTY keypad.

11. The method of claim 5, wherein the document comprises a list of items.

12. The method of claim 5, wherein the document comprises a menu of user-selectable options.

13. The method of claim 5, wherein the document comprises fields for data entry.

14. A method for displaying to a user of a mobile device a target screen and a context for the target screen, wherein the mobile device comprises a display device, a data entry device, and a memory device, and wherein the target screen and the context for the target screen was previously displayed to the user, the method comprising:
rendering, on the display device, the target screen and the context for the target screen;
storing, in the memory device, the target screen and the context for the target screen;
rendering, on the display device, at least one additional screen;
storing, in the memory device, the at least one additional screen and a context for the at least one additional screen;
receiving, from the user, a navigation request to display the target screen;
fetching, from the memory device, the target screen and the context for the target screen; and
rendering, on the display device, the target screen and the context for the target screen.

15. The method of claim 14, wherein the target screen and the context for the target screen and the at least one additional screen and the context for the at least one additional screen are stored in an ordered sequence such that the order in which the screens were displayed is preserved.

16. The method of claim 15, wherein the navigation request to display the target screen comprises a request to display the previous screen in the ordered sequence.

17. The method of claim 15, wherein the navigation request to display the target screen comprises a request to display the next screen in the ordered sequence.

18. The method of claim 15, wherein the navigation request to display the target screen comprises:
a request to render, on the display device, a plurality of items, wherein each of the plurality of items is associated with a stored screen; and
a selection, by the user, of one of the plurality of items, wherein the selection comprises a request to display the stored screen associated with the one of the plurality of items.

19. A method for populating an entry field on a mobile device, the method comprising:
storing, on the mobile device, a plurality of labels, wherein each of the plurality of labels is associated with a phrase;
receiving an input from a user, wherein the input comprises one of the plurality of labels;
retrieving, by the mobile device, the phrase associated with the input from storage; and
replacing the input from the user with the phrase associated with the input.

20. The method of claim 19, wherein the entry field comprises a text entry field and the phrase comprises text data.

21. The method of claim 19, wherein the entry field comprises a media entry field and the phrase comprises media data.

22. The method of claim 19, wherein at least one of the plurality of labels is defined by the user.

23. The method of claim 19, wherein the receiving an input from a user comprises:
rendering, on the mobile device, a plurality of items, wherein each of the plurality of items is associated with one of the plurality of labels; and
selecting, by the user, one of the plurality of items.

24. The method of claim 19, further comprising:
retrieving, by the mobile device, at least one of the plurality of labels from a data source external to the mobile device; and
storing the at least one of the plurality of labels on the mobile device.

25. The method of claim 24, wherein the data source external to the mobile device is a website, and wherein the at least one of the plurality of labels is defined by the user.

26. The method of claim 24, wherein the entry field comprises a text entry field and the phrase comprises text data.

27. The method of claim 24, wherein the entry field comprises a media entry field and the phrase comprises media data.

28. The method of claim 24, wherein the receiving an input from a user comprises:
rendering, on the mobile device, a plurality of items, wherein each of the plurality of items is associated with one of the plurality of labels; and
selecting, by the user, one of the plurality of items.

29. A method for delivering a cryptographically signed application that is customized to a specific user comprising:
a) providing a server computer that contains a user account and associated user data or a plurality of user accounts and associated user data;
b) providing a means for application signing;
c) allowing the user to edit the user data;
d) creating a resource file or a plurality of resource files incorporating items from the user data;
e) combining the resource file or resource files with an application executable object file or a plurality of application executable object files to create an application executable file;
f) signing the application executable file to produce the signed application; and
g) delivering the signed application to the user,
whereby the signed application is both secure and customized to the user.

30. A method for license protecting a mobile application, wherein the license protecting is accomplished through either a direct or an indirect sales channel, the method comprising:
a) packaging a license resource as part of a software application;
b) installing the application on a mobile device;
c) causing the application to prompt a user for the registration key;
d) alternatively causing the application to read an application key from the license resource; and
e) causing the application to connect to one or a plurality of data servers and for the data server to validate the registration key or the application key
whereby the application is able to support multiple licensing schemes and to provide protection against unauthorized distribution using a single code base.
